(19) United States
(12) Patent Application Publication
(10) Pub. No.: US 2004/0182147 A1
(43) Pub. Date: Sep. 23, 2004

(54) System and method for measuring compaction and other formation properties through cased wellbores

(76) Inventors: Frederick H. K. Rambow, Houston, TX (US); Mohamed Hashem, Mandeville, LA (US); Dennis Edward Dria, Houston, TX (US)

Correspondence Address: SHOOK, HARDY & BACON L.L.P., CHASE TOWER, SUITE 1600, 600 TRAVIS STREET, HOUSTON, TX, 77002-2911, US

(21) Appl. No.: 10/393,084

(22) Filed: Mar. 19, 2003

(51) Int. Cl. G01N 23/00

(52) U.S. Cl. 73/152.14; 73/152.52

(57) ABSTRACT

A system and method are disclosed for efficient and reliable deployment of radioactive markers and remote sensors in earth formations through cased wellbores. The markers and sensors are permanently deployed to obtain data on compaction, pressure and other useful formation properties.

### BACKGROUND OF THE INVENTION

1. Field of the Invention

The present invention relates to a method for measuring compaction and other formation properties adjacent a subterranean wellbore using radioactive markers or sensors. More particularly, the method includes a system which can be reliably used after casing is run in the wellbore.

2. Description of Related Art

Many subterranean reservoirs undergo compaction as hydrocarbons within the reservoir are produced or extracted and the fluid pressure in the reservoir decreases. As a result, compaction of the formation surrounding the reservoir, and even collapse of the wellbore used to access the reservoir, are likely to occur. In the absence of any reliable means to measure compaction or pressure, peak production rates are compromised in order to reduce the risk that the wellbore may collapse. Thus, information from compaction measurements can maximize production rates from reservoirs currently underutilized for fear of collapse. Likewise, knowing the differential pressure between different vertical zones of a formation, merely assumed to be at equilibrium, or knowing the relative production flow rates from various layers of the formation can improve production capacity from the reservoir. Consequently, the efficient production of hydrocarbons from a subterranean reservoir typically requires knowledge of various formation properties and parameters during the productive life of the reservoir, such as compaction and pressure.

Compaction is typically measured by the movement of the formation in and above and below a production zone or reservoir. In order to measure this movement, multiple radioactive markers are deployed directly into the formation and the surrounding region of interest representing a reservoir as the wellbore is being drilled. Each marker is identified by a unique radioactive signal which is monitored by conventional means within the wellbore, even after the wellbore is completed. Other formation properties such as pressure, temperature, and resistivity require more complicated electronics embodied in conventional sensors which are deployed directly into the formation surrounding the reservoir and/or directly into the production zone of the reservoir. Because conventional sensors are unable to communicate through the casing once the wellbore is completed, these sensors are extremely limited in their practical use.

One well-known method used to deploy markers and sensors requires a ballistic charge which essentially fires the marker or sensor directly into the formation. Several patents exemplify a “ballistic” means for deployment of markers such as U.S. Pat. Nos. 3,869,607; 4,396,838; and 5,753,813. This method, however, is associated with numerous inherent disadvantages. As markers are fired into the formation, they are often lost in the formation or get dislodged and circulate back to the surface in a slurry which poses environmental concerns. Further, the markers can either end up too far into the formation to detect or drop to the bottom of the wellbore, in either case being rendered useless. This method is particularly undesirable if the marker needs to be placed in a wall of the casing, commonly referred to as tagging. In most situations, cased wells simply cannot be tagged using this method.

The disadvantages inherent in a ballistic means for deployment are compounded when sensors are used. For example, U.S. Pat. Nos. 6,028,534; 6,234,257; and 6,467,387 each disclose a means to deploy data sensors during the drilling phase by shooting the sensor directly into the formation. For successful deployment, the sensor must survive both the launch and impact of the formation without substantial deformation or disintegration of any internal component; the sensor must ensure sufficient and straight penetration into all types of formation; and it must be capable of RF or other wireless communication through the formation to the data processing components in the wellbore. To this end, the '534 and '257 patents each disclose a means for communicating with each sensor to determine its location after it is deployed. Accordingly, these patents describe the use of a gamma ray pip-tag which is used in each sensor to emit a distinctive radioactive signal like that of a marker. This process, however, involves additional time and expense which adversely impacts the overall productivity of the reservoir.

The tools and methods described by the foregoing patents are undoubtedly impaired by the ballistic means used to deploy the markers and sensors. Further, this means of deployment is encumbered by the casing and may compromise production pressure within the wellbore where perforations are made in non-producing zones. In addition to these disadvantages, conventional communication between each sensor and the wellbore is cut off once the casing is run in the wellbore.

Accordingly, formation testing tools for use in cased wellbores, as exemplified by U.S. Pat. Nos. 6,070,662; 5,692,565; and 5,875,840, are often preferred. Like many formation testing tools used in wellbores without casing, these tools are generally limited to the acquisition of formation data while the tool is disposed in the wellbore and in physical contact with the formation region of interest. In other words, these tools are not designed to deploy markers or sensors capable of measuring formation properties over time.

For example, the '565 patent, incorporated herein by reference, describes a method for sampling formation properties behind a cased wellbore. As shown in FIG. 1 of the '565 patent (reproduced herein as FIG. 1) a flexible drilling shaft 18 is used to create a uniform casing perforation through which fluids may be extracted from the formation 10 and sampled. The inner housing 14 of the tool 12 contains a cartridge 26 which holds several plugs. A translation piston 16 shifts the inner housing 14 to move the cartridge 26 into position. A plug setting piston 25 then forces a plug from the cartridge 26 into the casing wall 11 to seal the perforation. This process can be repeated using several plugs in a single descent. Upon completion of the sampling process, the casing perforation is plugged, thereby preventing any further communication with the formation without repeating the perforation process.

As shown in FIG. 6c of the '565 patent (reproduced herein as FIG. 2) the tool 12 is designed to push a hollow steel plug 79 into the perforation in the casing wall to seal the casing 11 and provide pressure integrity. The plug 79 is composed of a tubular socket and a tapered plug 77. The tubular socket has a closed front end, a lip 78 and grooves in the center. The tapered plug 77 is inserted in the open end of the socket component. The lip 78 holds the socket and prevents it from sliding past the casing wall during insertion.

Conventional formation testing tools and methods, like that described by the '565 patent, consume substantial rig time. In most applications, the drill string must be removed from the wellbore before running the formation testing tool into the wellbore. Likewise, the formation testing tool must be removed from the wellbore before further production operations can be resumed.

Accordingly, it is a primary object of the present invention to provide an improved system and method for measuring compaction and other formation properties through cased wellbores using markers and/or sensors. It is a further object of the present invention to provide a system and method which enables more accurate and permanent placement of each marker and sensor in the formation.

It is another object of the present invention to provide a more efficient and reliable system and method for placing markers and sensors in the formation after the wellbore is lined with casing.

It is another object of the present invention to provide an environmentally safe system and method for placing markers and sensors in the formation.

It is another object of the present invention to provide a system and method which enables the placement of markers within the casing for tagging.

One advantage is the ability to communicate with sensors placed in the formation using the system and method of the present invention after the casing is run.

Another advantage is the ability to precisely locate sensors placed in the formation using the system and method of the present invention after the casing is run.

### SUMMARY OF THE INVENTION

The present invention is therefore designed to accomplish the foregoing objects and advantages, as well as various other objects and advantages, using a unique system and method that enables efficient, accurate and permanent placement of each marker and sensor in the formation through a cased wellbore. The system generally comprises a plurality of markers and/or sensors, depending on the particular formation property to be measured, and a means for deployment of the markers and sensors through the casing into the formation. Conventional means are used to seal perforations in the casing and communicate with each sensor. Markers are used to measure compaction of the formation while sensors may be used for the same purpose and to measure other formation properties such as pressure, temperature and resistivity. In short, the present invention substantially improves the efficiency and effectiveness of measuring compaction and other formation properties through cased wellbores.

In one embodiment of the invention, the deployment means comprises a tool with an inner housing. The inner housing includes a drill for perforating the casing and boring through a cement sheath or liner, as necessary, into the formation. The drill therefore, creates a separate passage through the casing, cement and formation at a desired depth and azimuth within the wellbore. Once each passage is complete, the drill is removed from the passage and the tool, suspended on a cable, is adjusted within the wellbore to align a cartridge within the inner housing containing markers and/or sensors with the passage. A piston then sets a first marker or first sensor in the casing. Once set, the inner housing is adjusted again to allow the drill to return to the passage where the first marker or first sensor is positioned in the casing. The drill, which is disabled from rotating, then forces the first marker or first sensor through the passage into the formation. In this manner, the exact location (depth and azimuth) of each marker and sensor may be immediately communicated to the surface and recorded upon its deployment, thereby eliminating the need for additional conventional tools and methods which are required to locate markers and sensors before the wellbore is lined with casing.

Once the first marker or first sensor is permanently in place, the drill is retracted within the inner housing and the process repeated using a second marker or second sensor at the same, or different, depth and azimuth in the wellbore as needed. Once the process is complete at a desired depth, the passage (perforation) through the casing is sealed. Depending on whether the casing must be tagged or whether sensors are deployed into the formation, the casing may be permanently sealed with a marker or in a manner that enables communication with a sensor.

The foregoing process is repeated until the requisite number of markers and sensors are deployed within the formation, cement and casing or until the deployment means must be retracted to reload the cartridge with additional markers and/or sensors. Depending on the formation property of interest and other wellbore conditions, multiple markers and sensors may be positioned within the formation at the same depth. Nevertheless, each passage through the casing is preferably sealed before production begins.

In one embodiment of the invention, multiple markers are used to measure compaction of the formation. Each marker generally comprises a substantially cylindrical housing having a bore which extends through an opening at one end of the marker housing. A plug is partially disposed through the opening within the bore and is integrally connected to the marker housing, however, may be tapered to provide a force fit within the bore. In either case, the bore is large enough to accommodate a radioactive element which is encased in a protective element positioned between a terminal end of the bore and a one end of the plug. Each marker is designed to pass freely through the passage or perforation made in the casing by the drill and includes a shearable lip circumscribing the opening in the marker housing. Upon contact with the inside diameter of the casing, the lip is sheared as the marker passes through the casing into the formation. In another embodiment, however, the marker may be used to seal the perforation in the casing using a different, slightly larger, marker housing. In this embodiment, the lip is an integral part of the marker housing and the plug is force-fit within the bore so that when the lip meets the inside diameter of the casing, preventing further movement of the marker, the plug proceeds within the bore thereby causing the end of the marker housing near the lip to expand within the perforation—reinforcing the seal where the marker housing contacts the casing. Thus, the marker, in this embodiment, can be used to tag the casing and seal the passage. Alternatively, the radioactive element and protective element may be eliminated if tagging is undesirable.

In another embodiment of the invention, a sensor is used to measure formation properties, such as pressure, temperature and resistivity. The sensor, like the marker, comprises a substantially cylindrical housing with a bore partially disposed through an opening at one end of the sensor housing. A plug is partially disposed through the opening and within the bore. In either case, the bore is large enough to accommodate the sensor electronics and antenna positioned between a terminal end of the bore and a one end of the plug. Additionally, the sensor housing includes a conduit which permits fluid communication between the formation and bore which contains the sensor electronics. The sensor electronics generally comprise components well-known to those skilled in the art such as a data sensor for measuring the various formation properties of interest (e.g., pressure, temperature or resistivity), a receiver for receiving remotely transmitted signals, and a transmitter for transmitting a signal representative of the sensor indicated property. In this embodiment, however, the plug is preferably connected to the sensor housing in order to prevent accidental impingement upon the sensor electronics and antenna. Each sensor is designed to pass through the passage or perforation made in the casing by the drill and includes a shearable lip circumscribing the opening in the sensor housing. Upon contact with the inside diameter of the casing, the lip is sheared as the sensor passes through the casing into the formation. In another embodiment, however, the sensor may be used to seal the perforation in the casing using a different, slightly larger, sensor housing. In this embodiment, the lip is an integral part of the sensor housing and the plug is force-fit within the bore so that when the lip meets the inside diameter of the casing, preventing further movement of the sensor, the plug proceeds within the bore thereby causing the end of the sensor housing near the lip to expand within the perforation—reinforcing the seal where the sensor housing contacts the casing. Thus, the sensor, in this embodiment, can be used to tag the casing, seal the passage and facilitate communication with other sensors deployed in the same passage. Alternatively, the sensor electronics may be eliminated if tagging is undesirable.

Because the markers and sensors are deployed in a non-ballistic manner through the casing into the formation, they may be manufactured from conventional materials which require less resistance to the ballistic forces typically encountered by conventional deployment means. The use of less resistant materials also facilitates improved communication between the sensor electronics to a position within the wellbore.

Once each marker and/or sensor are permanently in place, the corresponding formation properties of interest are monitored by means generally known to those skilled in the art.

### BRIEF DESCRIPTION OF THE DRAWINGS

The present invention is described with reference to the accompanying drawings. In the drawings, like reference numbers indicate identical or functionally similar elements.

FIG. 1 is a cross-sectional side view of the tool disclosed in FIG. 1 of the '565 patent.

FIG. 2 is a cross-sectional side view of the plug disclosed in FIG. 6c of the '565 patent.

FIG. 3 is a cross-sectional side view of a formation marker of the present invention.

FIG. 4 is a cross-sectional side view of the formation marker in FIG. 3 shown passing through the casing wall.

FIG. 5 is a cross-sectional side view of a casing marker of the present invention.

FIG. 6 is a partial cross-sectional side view of a logging tool suspended in a subterranean wellbore adjacent markers positioned in the casing, cement and formation.

FIG. 7 is a cross-sectional side view of a sensor of the present invention.

### DETAILED DESCRIPTION OF THE PREFERRED EMBODIMENTS

Deployment Means

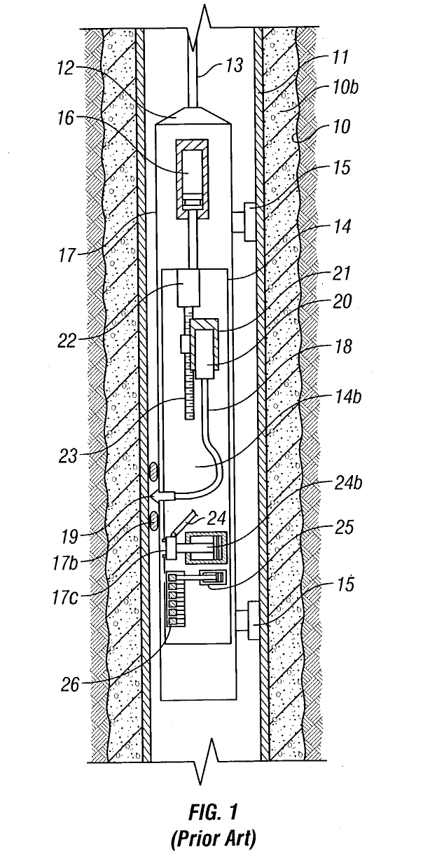

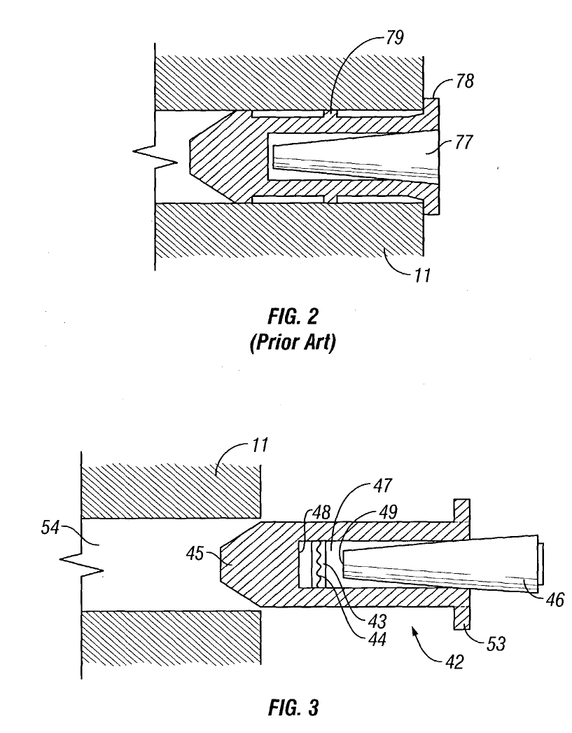

Referring to FIG. 1, the system includes a deployment means or tool 12. The tool 12 is suspended on a cable 13 inside a wellbore. The wellbore is drilled using methods well known in the art of oil and gas exploration. A casing wall 11 is added to stabilize and provide support for the rock formation 10 surrounding the wellbore. Cement 10b is also often added to the outside of the casing 11 to hold the casing 11 in place and provide support and a seal between the formation 10 and the casing 11.

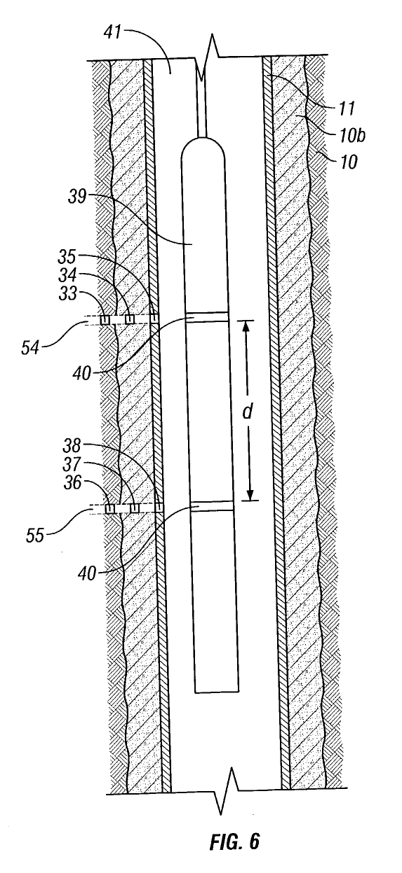

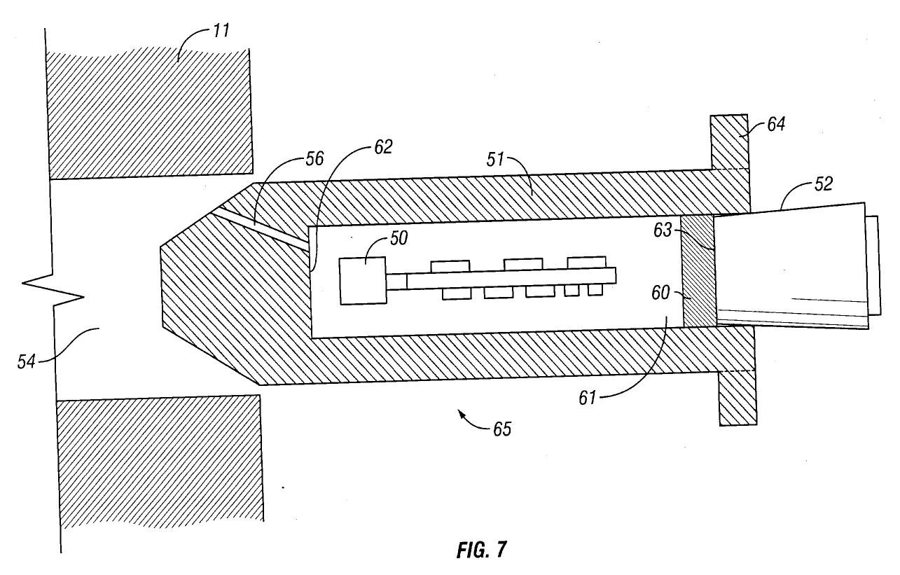

The primary components of the tool 12 include an inner housing 14 containing a drill 19 operated by a translation motor 22 and a drive motor 20. The housing 14 also contains a cartridge 26 which holds a plurality of markers and/or sensors. A housing translation piston 16 located within the body 17 of the tool 12 shifts the housing 14 to move the cartridge 26 or drill 19 into position. When the cartridge 26 is in position, a setting piston 25 forces a marker or sensor from the cartridge 26 into the casing 11. As described further in reference to FIG. 6, the tool 12 can deploy several markers through the casing into the formation 10 during a single descent within the wellbore.

The tool 12 also includes a fluid sampling means 24b which is unnecessary for the purposes of the present invention. Therefore, the fluid sampling means 24b is preferably eliminated to provide additional space in the housing 14 for a larger cartridge 26. Additionally, removal of the fluid sampling means 24b allows the tool 12 to be made more compact and economical. The cartridge 26 within the housing 14 may also be modified to include a circular design allowing the cartridge 26 to surround the drill 19. Consequently, the cartridge 26 would not have to move as far when it is maneuvered into position after drilling.

The Markers

Depending on the formation property to be measured, the system may include a plurality of radioactive markers to measure compaction of the formation surrounding a region of interest or reservoir. Referring now to FIG. 3, each marker 42 generally comprises a substantially cylindrical marker housing 45 having a bore 47 which extends through an opening at one end of the housing 45. A plug 46 is partially disposed through the opening within the bore 47, and is integrally connected to the marker housing 45, however, may be tapered to provide a force-fit within the bore 47. In either case, the bore 47 is large enough to accommodate a radioactive element 44 that is encased by a protective element 43 positioned between a terminal end of the bore 48 and one end of the plug 49. It will be appreciated by those skilled in the art that the radioactive element 44 may be a cesium wire with a unique signature or signal that is capable of being detected through the protective element 43 (e.g., steel) and the casing 11. It is contemplated, however, that the radioactive element 44 and protective element 43 may be positioned at other locations within the marker 42 without departing from the spirit of the invention. For example, the radioactive element 44 and protective element 43 could easily be placed in a milled out area within the plug 46 or press fit into a milled out area in the marker housing 45 at the terminal end of the bore 48.

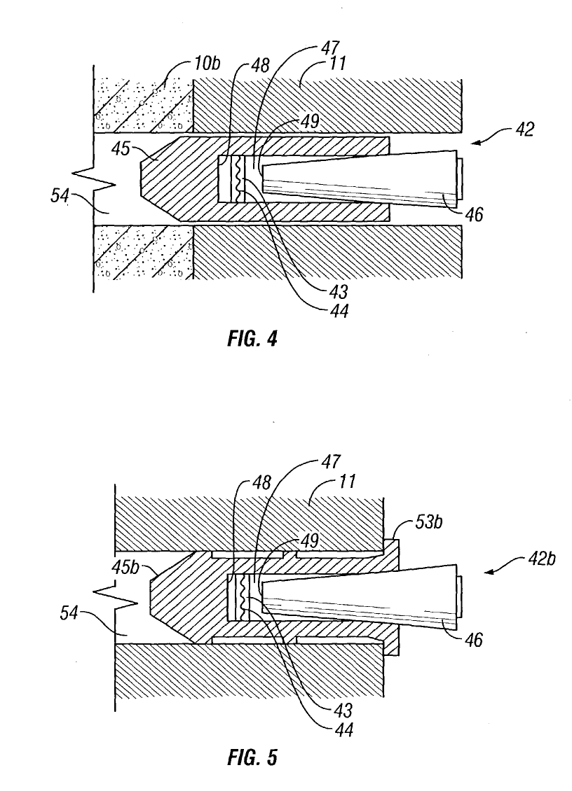

Each marker which is deployed through the casing 11 into the cement 10b or formation 10 is designed to pass freely through the passage or perforation 54 made in the casing 11 by the drill 19 and includes a shearable lip 53 circumscribing the opening in the marker housing 45. Upon contact with the inside diameter of the casing 11, the lip 53 is sheared as the marker 42 passes through the casing 11 into the cement 10b as shown in FIG. 4.

In another embodiment, however, the marker may be used to seal the perforation in the casing using a different, slightly larger, marker housing 45b as shown in FIG. 5. In this embodiment, the lip 53b is an integral part of the marker housing 45b and the plug 46 is force fit within the bore 47 so that when the lip 53b meets the inside diameter of the casing 11, preventing further radial movement of the marker 42b, the plug 46 proceeds within the bore 47 thereby causing the end of the marker housing 45b near the lip 53b to expand within the perforation 54—reinforcing the seal where the marker housing 45b contacts the casing 11. Thus, the marker 42b, in this embodiment, can be used to tag the casing 11 and seal the passage 54. Alternatively, the radioactive element 44 and protective element 43 may be eliminated if tagging is undesirable.

Using the tool 12 shown in FIG. 1 and a plurality of markers like the marker described in reference to FIG. 3, compaction of the formation surrounding a region of interest or reservoir can be measured and constantly monitored, if necessary. Additionally, the casing can be tagged in the manner thus described in reference to FIG. 5 for marking reference points on the casing and/or determining relative movement between the casing and the formation. As described further below, the precise alignment between the casing, cement and formation at any given depth can be monitored using the system and method of the present invention, which is useful for determining if a passage through the casing into the formation is blocked due to relative movement between the casing, cement and formation.

Referring now to FIGS. 1 and 6, one application or use of the tool 12 to measure compaction formation parameters is exemplified. A passage 54 is formed through the casing 11, cement 10b and formation 10 using the drill 19 at a predetermined depth and azimuth relative to the wellbore. The drill 19 is then removed from the passage 54 and the housing 14 is adjusted to align a first marker 33 carried in the cartridge 26 with the passage 54. The radioactive element 40 in each marker emits a signal unique to each marker for distinguishing it from the other markers. Once the marker 33 is aligned with the passage 54, the setting piston 25 forces the marker 33 into a position within the casing 11. After the marker 33 is inserted into the casing 11, the housing 14 is adjusted to realign the drill 19 with the marker 33. The drill 19 is then used to push the marker 33 through the casing 11 and cement 10b into a final position in the formation 10 as shown in FIG. 6. In order to prevent damage to the marker 33, the drill 19 is disabled from rotation during insertion of the marker 33. Thus, the drill 19 merely pushes the marker 33 to the final position in the formation 10.

Once the first marker 33 is in place, the drill 19 is retracted from the passage 54 and the housing 14 is adjusted to align a second marker 34 in the cartridge 26 with the passage 54. The second marker 34 is thus, positioned in the same manner as the first marker 33, however, at a final position in the cement 10b as shown in FIG. 6.

Once the second marker 34 is in place, the drill 19 is retracted from the passage 54 and the housing 14 is adjusted to align a third marker 35 in the cartridge 26 with the passage 54. The third marker 35, however, is set at a final position within the casing 11 as shown in FIG. 6. Because the third marker 35 is positioned in the casing 11, only the setting piston 25 is needed to position the third marker 35.

Because compaction is measured using markers typically positioned in the formation surrounding the reservoir, perforations in the casing where each passage is formed are undesirable. Consequently, it is often necessary to seal each passage with a marker as exemplified by the marker shown in FIG. 5. Thus, the third marker 35 can be used for tagging the casing 11 and sealing the passage 54. Alternatively, the radioactive element 44 and protective element 43 may be eliminated if tagging is undesirable.

Still referring to FIGS. 1 and 6, another passage 55 is formed through the casing 11, cement 10b and formation 10 at another predetermined depth and azimuth using the drill 19. In the same manner thus described for positioning the first marker 33, second marker 34 and third marker 35, a fourth marker 36, fifth marker 37, and sixth marker 38 are positioned within the formation 10, cement 10b and casing 11, respectively. Additional markers may be deployed in the same manner at various positions within the casing 11, cement 10b and formation 10 as deemed necessary. This process may be repeated during a single descent within the wellbore until the tool 12 must be removed from the wellbore to load the cartridge 26 with additional markers.

Once each marker is permanently in place, compaction may be measured by conventional means generally known to those skilled in the art. Illustrative of one such means is the use of the logging tool 39 shown in FIG. 6. The logging tool 39 is inserted into the wellbore 41 to measure the movement between multiple markers over time. The first marker 33, second marker 34, and third marker 35 represent a first set of markers positioned above a region of interest indicative of a reservoir and the fourth marker 36, fifth marker 37 and sixth marker 38 represent a second set of markers positioned below the region of interest. Spectral gamma ray detectors 40 are positioned on the logging tool 39 in spaced relation to one another that corresponds with the distance (d) between the first set of markers and the second set of markers. Each detector 40 is capable of detecting at least one unique radioactive signal emitted by a marker. As the logging tool 39 moves within the wellbore 41 past the first set of markers and second set of markers, an initial position is detected for each set of markers. Once the initial position of the first set of markers and second set of markers is recorded, the logging tool 39 is then used to monitor longitudinal movement of the first set of markers and second set of markers over time.

For example, at some time during the production process, compaction may be monitored by lowering the logging tool 39 within the wellbore 41. Because the exact location (depth and azimuth) of the first set of markers and second set of markers was recorded upon their initial deployment, the detectors 40 are able to detect whether the first set of markers and second set of markers are closer together, indicating compaction. Similarly, the detectors 40 are able to detect whether there is longitudinal movement between the first marker 33 and the third marker 35, or the fourth marker 36 and the sixth marker 38, indicating a shift between the formation 10 and casing 11. In either case, the ability to monitor these parameters over time is invaluable to the overall productivity of the reservoir.

The Sensors

In the same manner thus described for the deployment of markers, a plurality of sensors may be deployed to measure compaction and other formation properties such as pressure, temperature and resistivity.

Referring now to FIG. 7, a sensor 65, like the marker, comprises a substantially cylindrical housing 51 having a bore 61 which extends through an opening at one end of the sensor housing 51. A plug 52 is partially disposed through the opening within the bore 61. The bore 61 is large enough to accommodate the sensor electronics 50 and antennae 60 positioned between a terminal end of the bore 62 and one end of the plug 63. It is contemplated, however, that the sensor electronics 50 and antennae 60 may be placed at other locations within the sensor housing 51 without departing from the spirit of the invention. Additionally, the sensor housing 51 includes a conduit 56 which permits fluid communication between the formation 10 and the bore 61 containing the sensor electronics 50. The sensor electronics 50 generally comprise components well known to those skilled in the art, such as a data sensor for measuring various formation properties of interest (e.g., pressure, temperature or resistivity); a receiver for receiving remotely transmitted signals; and a transmitter for transmitting a signal representative of the sensor indicated formation property. The plug 52, however, is preferably connected to the sensor housing 51 in order to prevent accidental impingement on the sensor electronics 50 and antennae 60.

Each sensor 65 is designed to pass through the passage or perforation 54 made in the casing 11 and includes a shearable lip 64 circumscribing the opening in the sensor housing 51. Upon contact with the inside diameter of the casing 11, the lip 64 is sheared as the sensor 65 passes through the casing 11 into the formation. In another embodiment (not shown) the sensor may be used to seal the perforation in the casing using a different, slightly larger, sensor housing. In this embodiment, the lip is an integral part of the sensor housing and the plug is force fit within the bore so that when the lip meets the inside diameter of the casing, preventing further radial movement of the sensor, the plug proceeds within the bore, thereby causing the end of the sensor housing near the lip to expand within the perforation—reinforcing the seal where the sensor housing contacts the casing. Thus, the sensor can be used to tag the casing, seal the passage and facilitate communication with other sensors deployed in the same passage by conventional means generally known to those skilled in the art. If tagging is unnecessary, however, the sensor electronics 50 can be eliminated and the antennae 60 modified in the manner described in the '662 patent to seal the passage and facilitate communication with other sensors deployed in the same passage.

Multiple sensors may, therefore, be deployed and used in the same manner thus described for the markers until the tool 12 must be removed from the wellbore to load the cartridge 26 with additional sensors. Additionally, multiple sensors may be deployed into the formation production zone or reservoir to measure other formation properties, such as pressure, temperature and resistivity. Once each sensor is permanently in place, these formation properties may be measured intermittently or constantly in the manner described in the '662 patent or as described in U.S. patent application Ser. Nos. 09/768,655; 09/769,046; and 09/798,192.

The present invention provides a more efficient and reliable system and method for placing markers and sensors in the formation after the wellbore is lined with casing. Because the markers and sensors are deployed in a non-ballistic manner, they may be manufactured from conventional materials which require less resistance to the ballistic forces typically encountered by conventional deployment means. The use of less resistant materials also facilitates improved communication between the sensor electronics to a position within the wellbore. And, multiple sensors and markers can be loaded in the cartridge 26 of the tool 12 and deployed during a single descent within the wellbore due to their uniform design which enables them to be aligned in any order within the cartridge 26.

Further modifications and embodiments of many aspects of this invention will also be obvious to those skilled in the art of oil and gas exploration techniques. The description contained herein is illustrative and should be construed as teaching those skilled in the art the general manner of carrying out the invention. Many elements may be substituted for those elements of the invention described herein. Many changes may be made without departing from the spirit and scope of this invention.

We claim:

1. A system for measuring a property of an earth formation through a wellbore lined with casing, comprising:
at least one of a marker and a sensor;
a means for deployment of at least one of said marker and sensor through said casing into said formation; and
a means for detecting a signal representative of said formation property from at least one of said marker and sensor.

2. The system of claim 1, wherein said formation property is at least one of compaction, pressure, temperature and resistivity.

3. The system of claim 2, further comprising a plurality of markers.

4. The system of claim 2, further comprising a plurality of sensors.

5. The system of claim 3, wherein said marker comprises:
a substantially cylindrical housing having a bore which extends through an opening at one end of said housing;
a plug partially disposed through said opening within said bore; and
a radioactive element encased within a protective element positioned between a terminal end of said bore and 6ne end of said plug.

6. The system of claim 5, wherein said housing comprises a shearable lip circumscribing said opening for maintaining alignment of the plurality of markers.

7. The system of claim 4, wherein said sensor comprises:
a substantially cylindrical housing having a bore which extends through an opening at one end of said housing;
a plug partially disposed through said opening within said bore;
a sensor electronics package and antenna positioned between a terminal end of said bore and one end of said plug; and
a conduit through said housing for permitting fluid communication between said formation and said sensor electronics package.

8. The system of claim 7, wherein said housing comprises a shearable lip circumscribing said opening for maintaining alignment of said plurality of sensors.

9. The system of claim 1, wherein said deployment means comprises:
a drill for creating a passage for at least one of said marker and sensor and positioning at least one of said marker and sensor in the formation;
a cartridge for carrying at least one of said marker and sensor;
a piston for initially setting at least one of said marker and sensor in said casing; and
a moveable housing for aligning said piston with said passage.

10. The system of claim 9, further comprising a plurality of markers and a plurality of sensors carried by said cartridge.

11. The system of claim 3, wherein said detecting means comprises a logging tool having a plurality of spectral gamma ray detectors for measuring said compaction.

12. The system of claim 4, wherein said detecting means comprises a logging tool having a plurality of receivers for measuring at least one of said compaction, pressure, temperature and resistivity.

13. A system for monitoring movement of at least one of a cement sheath and casing liner within a wellbore comprising:
at least one of a marker and a sensor;
a means for deployment of at least one of said marker and sensor into at least one of said cement sheath and casing liner; and
a means for detecting a signal representative of a movement of at least one of said cement sheath and casing liner from at least one of said marker and sensor.

14. The system of claim 13, further comprising a plurality of markers.

15. The system of claim 13, further comprising a plurality of sensors.

16. The system of claim 14, wherein said marker comprises:
a substantially cylindrical housing having a bore which extends through an opening at one end of said housing;
a plug partially disposed through said opening within said bore; and
a radioactive element encased within a protective element positioned between a terminal end of said bore and one end of said plug.

17. The system of claim 15, wherein said sensor comprises:
a substantially cylindrical housing having a bore which extends through an opening at one end of said housing;
a plug partially disposed through said opening within said bore; and
a sensor electronics package and antenna positioned between a terminal end of said bore and one end of said plug.

18. The system of claim 16, wherein said housing comprises a lip circumscribing said opening and said plug is moveable within said bore.

19. The system of claim 18 wherein said deployment means positions at least one of said marker and sensor in the casing liner.

20. A method for measuring a property of an earth formation through a wellbore lined with casing comprising the steps of:
forming a passage through said casing into said formation;
deploying at least one of a marker and a sensor into said formation; and
detecting a signal representative of said formation property from at least one of said marker and sensor.

21. The method of claim 20, wherein said passage is formed with a drill capable of perforating said casing and boring through said formation.

22. The method of claim 21, wherein at least one of said marker and sensor are deployed by said drill.

23. The method of claim 20, wherein said signal is detected by a logging tool having a plurality of spectral gamma ray detectors for monitoring a plurality of markers and measuring said formation property when said formation property is compaction.

24. The method of claim 20, wherein said signal is detected by a logging tool having a plurality of receivers for monitoring a plurality of sensors and measuring said formation property when said formation property is at least one of compaction, pressure, temperature and resistivity.

25. A method for measuring movement of at least one of a cement sheath and casing liner within a wellbore comprising the steps of:
forming a passage through at least one of said cement sheath and casing liner;
deploying at least one of a marker and a sensor into at least one of said cement sheath and casing liner; and
detecting a signal representative of said movement of at least of one said cement sheath and casing liner from at least one of said marker and sensor.

26. The method of claim 25, wherein said passage is formed with a drill capable of perforating at least one of said cement sheath and casing liner.

27. The method of claim 26, wherein at least one of said marker and sensor are deployed by said drill.

28. The method of claim 25, wherein said signal is detected by a logging tool having a plurality of spectral gamma ray detectors for monitoring a plurality of markers and movement of at least one of said cement sheath and casing liner.

29. The method of claim 25, wherein said signal is detected by a logging tool having a plurality of receivers for monitoring a plurality of sensors and movement of at least one of said cement sheath and casing liner.
